(19) United States
(12) Patent Application Publication
(10) Pub. No.: US 2026/0210743 A1
(43) Pub. Date: Jul. 23, 2026

(54) DEVICE FOR PROVIDING AN EXCITATION CURRENT AT A MAGNETIC-INDUCTIVE FLOWMETER, AND MAGNETIC-INDUCTIVE FLOWMETER

(71) Applicant: Endress+Hauser Flowtec AG, Reinach (CH)

(72) Inventors: Dirk Sütterlin, Schopfheim (DE); Andre Spahlinger, Bad Bellingen (DE); Markus Rüfenacht, Diepflingen (CH)

(21) Appl. No.: 19/141,173

(22) PCT Filed: Dec. 20, 2023
(86) PCT No.: PCT/EP2023/086845

§ 371 Date: Jun. 19, 2025

(30) Foreign Application Priority Data
Dec. 21, 2022 (DE) 10 2022 134 361.8

(51) Int. Cl. G01F 1/60; G01F 1/58

(52) U.S. Cl. CPC G01F 1/60; G01F 1/586

(57) ABSTRACT

A device for providing an excitation current at a magnetic-inductive flowmeter comprises an integrated circuit comprising an H-bridge having a first, a second, a third and a fourth transistor; the H-bridge is connected to an input and an output of the magnetic-field-generating device. The integrated circuit includes control logic designed control inputs of the first, second, third and fourth transistors. The integrated circuit includes a fifth transistor which is electrically connected to an input for a hold voltage which is likewise part of the integrated circuit and is designed to convert an input voltage into the hold voltage. The control logic is connected to the input of the fifth transistor. The device includes a microcontroller which is separate from the integrated circuit and which is designed to deliver the operating signal to the integrated circuit and to receive measurement signals from the integrated circuit.

The invention relates to a device for providing an excitation current at a magnetic-inductive flowmeter, and to a magnetic-inductive flowmeter.

Magnetic-inductive flowmeters are used for determining the flow rate and the volumetric flow of a flowing medium in a pipe. A distinction is made here between in-line magnetic-inductive flowmeters and magnetic-inductive flow measurement probes, which are inserted into a lateral opening of a pipe. A magnetic-inductive flowmeter has a magnetic-field-generating device for generating a magnetic field. A main axis of the magnetic field runs essentially perpendicular to the flow direction of the flowing medium. Saddle coils or solenoids are usually used for this purpose. In order to realize a predominantly homogeneous magnetic field, pole shoes are additionally formed and attached relative to the flow direction such that the magnetic field lines run over the entire tube cross section essentially perpendicular to the transverse axis or in parallel with the vertical axis of the measuring tube. In addition, a magnetic-inductive flowmeter has a measuring tube for guiding the medium on the outer lateral face of which the magnetic-field-generating device is arranged. A pair of measurement electrodes attached to the lateral surface of the measuring tube taps a measurement voltage or potential difference which is perpendicular to the direction of flow and to the magnetic field and arises when a conductive medium flows in the direction of flow when the magnetic field is applied. Since, according to Faraday's law of induction, the tapped measurement voltage depends on the velocity of the flowing medium, the flow rate and/or with the inclusion of a known tube cross section, the volumetric flow can be determined from the measured induced measurement voltage.

In contrast to a magnetic-inductive flowmeter, which comprises a measuring tube for conducting the medium with an attached device for generating a magnetic field penetrating the measuring tube and which also comprises measuring electrodes, magnetic-inductive flow measurement probes are inserted with their usually circular cylindrical housings into a lateral opening of a pipe and fastened in a fluid-tight manner. A special measuring tube is no longer necessary. The measurement electrode arrangement and coil arrangement, mentioned at the outset, on the lateral surface of the measuring tube are omitted and are replaced by a device for producing a magnetic field, which device is arranged in the interior of the housing and in direct proximity to the measurement electrodes and is designed such that an axis of symmetry of the magnetic field lines of the produced magnetic field perpendicularly intersects the front face or the face between the measurement electrodes. In the prior art, there is already a plurality of different magnetic-inductive flow measurement probes.

Magnetic-inductive flowmeters are often used in process and automation engineering for fluids, starting from an electrical conductivity of approximately 5 μS/cm. Corresponding flow measurement devices are sold by the applicant in a wide variety of embodiments for various fields of application, for example under the names PROMAG or MAGPHANT.

DE 10 2016 122 914 B4 discloses a device for providing an excitation current at a magnetic-inductive flowmeter. The device has an H-bridge control circuit designed to deliver control signals to respective inputs of the first, second, third and fourth transistors of an H-bridge in order to control the provision of a specified current to the excitation coil by means of the H-bridge. An on-chip inductive transformer for electrically isolating and inductively coupling a received input signal to the H-bridge is further provided in order to control at least one of the first, second, third and fourth transistors of the H-bridge. Furthermore, the device has a radio-frequency interference (RFI) attenuation circuit in a signal path between the differential amplifier circuit and the analog-to-digital converter. Furthermore, the device has trimmed resistors designed to adjust respective gains of an operational amplifier and to provide a DC-coupled differential signal path through the differential amplifier. A digital signal processor circuit coupled to the analog-to-digital converter is further provided in order to receive digital signals containing information from the electromagnetic flux sensor. To process these, the digital signal processor circuit has a digital FIR (finite impulse response) bandpass filter circuit.

The object of the invention is to further develop the current solutions.

The object is achieved by the device according to claim 1 and the magnetic-inductive flowmeter according to claim 15.

The device according to the invention for providing an excitation current at a magnetic-inductive flowmeter for determining a flow-rate-dependent measured variable of a flowable medium, said device having a measuring tube, a magnetic-field-generating device and a device for detecting an induced measuring voltage in the medium, comprises:
an integrated circuit, comprising:
   an H-bridge which has a first, a second, a third and a fourth transistor,
      wherein the H-bridge is connected to an input via a first node and to an output of the magnetic-field-generating device via a second node,
   a control logic which is designed to deliver control signals to respective inputs of the first, second, third and fourth transistors of the H-bridge in order to control the provision of an operating signal to the magnetic-field-generating device by means of the H-bridge,
   a fifth transistor which is electrically connected to an input for a hold voltage Vhold, and in particular to a buck converter, which is likewise part of the integrated circuit and is designed to convert an input voltage into the hold voltage Vhold,
      wherein the control logic is designed to deliver control signals to the input of the fifth transistor in order to set a hold duration Thold of the hold voltage Vhold and a frequency with which the hold voltage Vhold repeats; and
a microcontroller which is designed to deliver the operating signal to the integrated circuit and to receive measurement signals from the integrated circuit,
   wherein the microcontroller is arranged separately from the integrated circuit.

The integration of the H-bridge, the control logic and the fifth transistor into the integrated circuit has the advantage that less space is required on the circuit board of the device for providing the excitation current. All electronic components of the device for providing the excitation current for the magnetic-field-generating device are arranged on the circuit board.

Another advantage of the integration is the associated simplified purchasing situation. It is no longer necessary to purchase individual electronic components that form the H-bridge and the control logic and interconnect them on the circuit board; instead, it is sufficient to provide a single chip for each magnetic-inductive flowmeter.

The main advantage, however, is that the integration means that the time-critical functions for preventing short circuits no longer have to be controlled via the software, but now via the hardware, i.e., the integrated circuit itself.

A typical voltage curve applied to the magnetic-field-generating device of a magnetic-inductive flowmeter has alternating phases with different current flow directions or different voltage signs. During the measurement phases, a hold voltage Vhold is applied. The hold voltage Vhold is applied for a hold duration Thold. A typical voltage curve consists of alternating square-wave voltages. Voltage curves are also known which have rest phases between the alternating square-wave voltages, during which no voltage is applied to the magnetic-field-generating device.

Advantageous embodiments of the invention are the subject matter of the dependent claims.
One embodiment provides that the fifth transistor is designed as an n-channel transistor.
One embodiment provides that the integrated circuit further comprises:
   a sixth transistor which is electrically connected to an input for a shot voltage Vshot, and in particular to a boost converter, which is likewise part of the integrated circuit and is designed to convert an input voltage into the shot voltage Vshot,
      wherein the control logic is designed to deliver control signals to the input of the sixth transistor in order to set a shot duration Tshot of the shot voltage Vshot and a frequency with which the shot voltage Vshot repeats.

Conventional motor driver ICs are designed for exactly one constant bridge voltage. The disadvantage is that only slow and sluggish systems can be realized.

In order to reach a target current more quickly when switching, it is advantageous to apply a shot voltage for a shot duration before applying the hold voltage. The shot voltage is significantly higher than the hold voltage. The hold voltage is usually in a voltage range of 1 to 15 V, while the shot voltage can usually be between 50 and 100 V.

The switching from a shot voltage to a hold voltage occurs within a few microseconds. To date, no integrated circuits are known that meet this requirement.

The use of transistors instead of diodes ensures that significantly lower energy losses can be expected.
One embodiment provides that the sixth transistor is designed as a p-channel transistor.
One embodiment provides that the device further comprises:
   a first electrical resistor which is arranged separately from the integrated circuit,
      wherein the H-bridge is connected to the first resistor via a third node,
      wherein the first resistor is electrically connected to the fifth transistor,
      wherein the integrated circuit further comprises:
   a first measuring unit which is connected in parallel to the first resistor and is designed to measure a voltage drop across the first resistor, in particular with respect to a provided reference potential, and to provide this in the form of a measurement signal at an output IHigh for the microcontroller.

The separation of the first electrical resistor from the integrated circuit has the advantage that, on the one hand, the first electrical resistor does not have to be implemented in the integrated circuit in a complex manner and, on the other hand, that different integrated circuits are not required for each application with different operating voltage ranges. Instead, a first electrical resistor adapted to the voltage range used can be employed for each magnetic-inductive flowmeter. The first electrical resistor can therefore be arranged on the circuit board.
One embodiment provides that the device further comprises:
   a second electrical resistor,
      wherein the H-bridge is electrically connected via a fourth node to the second electrical resistor, which is arranged separately from the integrated circuit,
      wherein the second resistor is electrically connected to a reference potential, wherein the integrated circuit comprises:
   a second measuring unit which is designed to measure a present current through the second resistor and to provide this in the form of a measurement signal at an output ILow for the microcontroller.

The separation of the second electrical resistor from the integrated circuit has the advantage that, on the one hand, the second electrical resistor does not have to be implemented in the integrated circuit in a complex manner and, on the other hand, that different integrated circuits are not required for each application with different operating voltage ranges. Instead, a second electrical resistor adapted to the voltage range used can be employed for each magnetic-inductive flowmeter. The second electrical resistor can therefore be arranged on the circuit board.
One embodiment provides that the second measuring unit is designed to amplify a voltage at an output SenseLow towards the second resistor.
One embodiment provides that the integrated circuit further comprises:
   a seventh transistor which is connected in parallel to the h-bridge,
      wherein the control logic is designed to deliver control signals to the input of the fifth transistor in order to bridge the H-bridge for diagnostics of the magnetic-field-generating device and/or of the H-bridge, in particular of the first, second, third and/or fourth transistor.
One embodiment provides that the integrated circuit further comprises:
   an eighth transistor which is electrically connected to an input for a reference potential,
      wherein the control logic is designed to deliver control signals to the input of the eighth transistor in order to electrically set the magnetic-field-generating device to the reference potential.
One embodiment provides that the device further comprises:
   a storage unit,
      wherein the fifth and sixth transistors are designed such that, in the event that a present voltage at a node connecting the fifth and sixth transistors is greater than a present voltage at the boost converter, excess energy of the magnetic-field-generating device is stored in the storage unit via the boost converter.

For example, the sixth transistor can be a p-channel transistor, which allows the excess energy to be directed into the storage unit. The fifth transistor in this case is an n-channel transistor, which prevents the excess energy from being transferred to the buck converter.
One embodiment provides that the integrated circuit further comprises:
   a digital-to-analog converter which is designed to control the boost converter and/or the buck converter.
One embodiment provides that the device further comprises:
   a digital-to-analog converter which is designed to control the boost converter and/or the buck converter,
      wherein the digital-to-analog converter is arranged separately from the integrated circuit.
One embodiment provides that the integrated circuit further comprises:
   an analog-to-digital converter which is designed to convert the measured voltage drop and/or the measured current into a digital measurement signal.
One embodiment provides that the device further comprises:
   an analog-to-digital converter which is designed to convert the measured voltage drop and/or the measured current into a digital measurement signal,
      wherein the analog-to-digital converter is arranged separately from the integrated circuit.

The magnetic-inductive flow meter according to the invention for determining a flow-rate-dependent measurement variable of a flowable medium comprises:
a measuring tube for conducting the medium,
a magnetic-field-generating device for generating a magnetic field that penetrates the measuring tube;
an operating circuit for operating the magnetic-field-generating device,
   wherein the operating circuit comprises a device according to any one of the preceding claims; and
a device for detecting an induced measurement voltage in a medium.

The core of the invention is the optimal integration of electrical functional blocks/groups of a magnetic-inductive flowmeter in one chip in order to optimize costs. Patent DE 10 2016 122 914 B4 refers to the integration of various circuits. However, the present inventive step is to do this in such a way that it is economically optimized with respect to a magnetic-inductive flowmeter. For this purpose, the division of the required functional blocks for coil current control is optimally selected between discrete and integrated implementation, resulting in an economic advantage for the overall system.

The invention is explained in greater detail with reference to the following figures. in which:

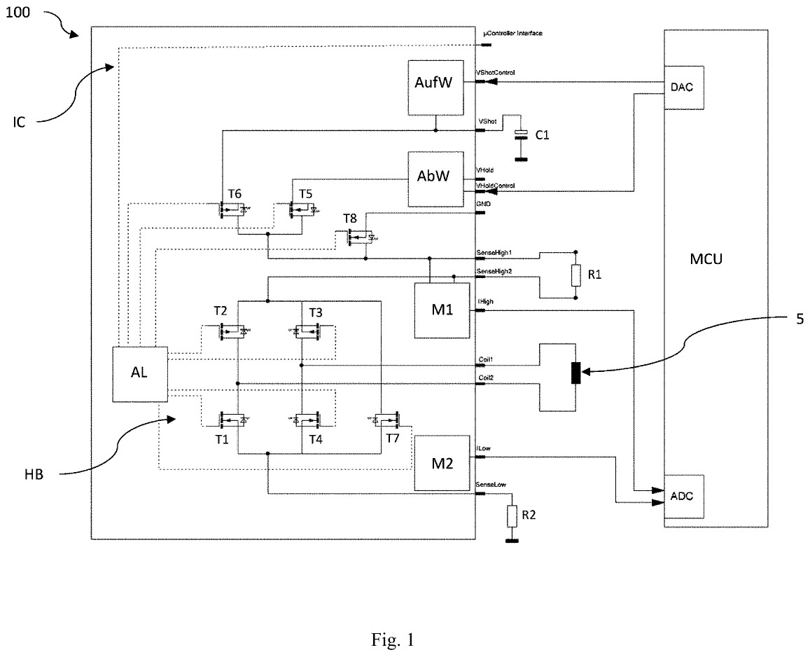

FIG. 1: shows an embodiment of the device according to the invention for providing an excitation current at a magnetic-inductive flowmeter; and

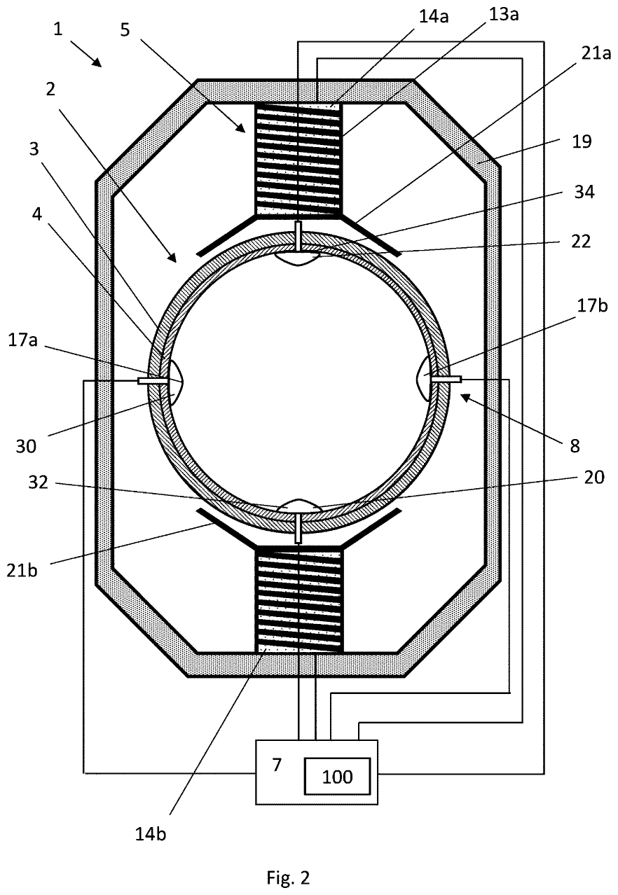

FIG. 2: shows a magnetic-inductive flowmeter according to the invention with a device for providing the excitation current.

FIG. 1 shows an embodiment of the device 100 according to the invention for providing an excitation current at a magnetic-inductive flowmeter (see FIG. 2). The device 100 for providing the excitation current at a magnetic-inductive flowmeter comprises an integrated circuit IC, which is arranged on a circuit board of the device 100 and is part of the operating circuit. The integrated circuit IC has an H-bridge HB which has a first, a second, a third and a fourth transistor T1, T2, T3, T4. The first transistor T1 and the second transistor T2 are connected in series and together in parallel to the third transistor T3 and the fourth transistor T4, which are also connected in series to one another. The H-bridge HB is connected via a first node to an input Coil1 of the integrated circuit IC and via a second node to an output Coil2 of the integrated circuit IC. The input Coil1 and the output Coil2 are connected to the magnetic-field-generating device 5 and thus form the interface between the magnetic coil and the operating circuit. The first node is located between the third and fourth transistor T3, T4. The second node is located between the first and second transistor T1, T2.

The integrated circuit IC also has a control logic AL which is designed to deliver control signals to respective inputs of the first, second, third and fourth transistors T1, T2, T3, T4 of the H-bridge HB in order to control the provision of an operating signal to the magnetic-field-generating device 5 by means of the H-bridge HB. The control logic AL is a digital logic circuit with conventional logic gates. The control logic is used to execute time-critical actions in the hardware in order to prevent short circuits from occurring during the dynamic phases. The task of the control logic is usually performed by the software. The control logic AL is designed to control the transistors, i.e., to switch the transistors on or off.

The integrated circuit IC also has a fifth transistor T5 which is electrically connected to an input for a hold voltage Vhold, and in particular to a buck converter AbW, which is likewise part of the integrated circuit IC and is designed to convert an input voltage into the hold voltage Vhold. The control logic AL is designed to deliver control signals to the input of the fifth transistor T5 in order to set a hold duration Thold of the hold voltage Vhold and a frequency with which the hold voltage Vhold repeats. The fifth transistor T5 is designed as an n-channel transistor. This prevents excess energy present in the magnetic-field-generating device 5 after switching the magnetic field from flowing into the buck converter.

The integrated circuit IC further comprises a sixth transistor T6 which is electrically connected to an input for a shot voltage Vshot, and in particular to a boost converter AufW, which is likewise part of the integrated circuit IC and is designed to convert an input voltage into the shot voltage Vshot. The shot duration is set via the sixth transistor. For this purpose, the control logic AL is designed to deliver control signals to the input of the sixth transistor T6 in order to set a shot duration Tshot of the shot voltage Vshot and a frequency with which the shot voltage Vshot repeats. The sixth transistor T6 is designed as a p-channel transistor to ensure a flow of excess energy into the storage unit C1. In the event that a present voltage at a node connecting the fifth and sixth transistors T5, T6 is greater than a present voltage at the boost converter AufW, the excess energy of the magnetic-field-generating device 5 is stored in the storage unit C1 via the boost converter AufW. The stored energy can then be used to generate the shot voltage Vshot of the next phase.

Not part of the integrated circuit is the microcontroller MCU, which is likewise arranged on the circuit board and is designed to deliver the operating signal to the integrated circuit IC and to receive measurement signals from the integrated circuit IC.

In addition to the microcontroller MCU, a first electrical resistor R1 is also provided, which is arranged separately from the integrated circuit IC and is electrically connected to the H-bridge HB via a third node. Furthermore, the first resistor R1 is electrically connected to the fifth transistor T5 (i.e., in series). The first resistor R1 is used to monitor the magnetic-field-generating device 5. For this purpose, the integrated circuit has a first measuring unit M1 which is connected in parallel to the first resistor R1 and is designed to measure a voltage drop across the first resistor R1, in particular with respect to a provided reference potential, and to provide this in the form of a measurement signal at an output IHigh for the microcontroller MCU. The integrity of the magnetic-field-generating device is monitored using the measurement signal.

For the diagnostics of the magnetic-field-generating device 5, a second electrical resistor R2 is additionally provided, which is arranged on the circuit board and is separate from the integrated circuit IC. The H-bridge HB is electrically connected to the second electrical resistor R2 via a fourth node. Furthermore, the second resistor R2 is directly electrically connected to a reference potential (e.g., the ground potential). Furthermore, the second measuring unit M2 is designed to amplify a voltage at an output SenseLow towards the second resistor R2 and to output this value at the ILow.

A second measuring unit M2, which is also part of the integrated measuring circuit IC, is necessary for the diagnostics. The second measuring unit M2 is designed to measure a present current through the second resistor R2 and to provide this in the form of a measurement signal at an output ILow for the microcontroller MCU. The microcontroller MCU is designed to monitor, or determine and optionally output, the integrity of the magnetic-field-generating device based on the measurement signal.

The integrated circuit IC further comprises a seventh transistor T7, which is connected in parallel to the H-bridge HB and is used to conduct the current around the H-bridge HB. For this purpose, the control logic AL is designed to deliver control signals to the input of the fifth transistor T5 in order to bridge the H-bridge HB for diagnostics of the magnetic-field-generating device 5 and/or of the H-bridge HB, in particular of the first, second, third and/or fourth transistor T1, T2, T3, T4.

The integrated circuit IC further comprises an eighth transistor T8, which is electrically connected to an input for a reference potential (e.g., for a ground potential) so that the magnetic-field-generating device can be set to a desired potential. For example, the magnetic-field-generating device, in particular the coils, can be grounded if necessary. For this purpose, the control logic AL is designed to deliver control signals to the input of the eighth transistor T5 in order to electrically connect the magnetic-field-generating device to the input of the reference potential and to set said device to the reference potential.

In one embodiment (not shown), a digital-to-analog converter DAC, which is designed to control the boost converter AufW and/or the buck converter AbW, is also part of the integrated circuit. In addition, the integrated circuit has an analog-to-digital converter ADC, which is designed to convert the measured voltage drop and/or the measured current into a digital measurement signal.

Alternatively, the digital-to-analog converter DAC and the analog-to-digital converter ADC are arranged separately from the integrated circuit IC as shown and are designed to control the boost converter AufW and/or the buck converter AbW or to convert the measured voltage drop and/or the measured current into a digital measurement signal.

For this purpose, the integrated circuit IC has corresponding inputs VShotControl and VHoldControl, via which the digital-to-analog converter DAC communicates with the electronic components of the integrated circuit. Furthermore, the integrated circuit IC has outputs IHigh and ILow, via which determined measured signals of the coil diagnostics are forwarded to the analog-to-digital converter ADC.

FIG. 2 shows a magnetic-inductive flowmeter 1 according to the invention with a device 100 for providing the excitation current. The structure and measuring principle of a magnetic-inductive flow meter 1 are known in principle. A flowable medium having an electrical conductivity is conducted through a measuring tube 2. The measuring tube 2 comprises a medium-contacting carrier tube 3, which is usually made of, or at least comprises, steel, ceramic, plastic or glass. A magnetic-field-generating device 5 for generating a magnetic field is arranged on the carrier tube 3 such that the magnetic field lines are oriented substantially perpendicularly to a longitudinal direction defined by a measuring tube axis. The magnetic-field-generating device 5 typically comprises a saddle coil or at least one solenoid 6i. A coil core 14i usually extends through a receptacle 15 of the coil 6i. The receptacle 15 is to be understood as the volume which is bounded by the coil wire that forms the coil 6i. The receptacle 15 of the coil 6i can thus be formed by a coil holder or by the imaginary enclosed volume. The latter occurs when the coil wire of the coil 6i is wound directly around the coil core 14i. The coil core 14i is formed from a magnetically conductive, in particular soft, magnetic material. The device 5 for generating the magnetic field comprises a pole shoe 21i which is arranged at one end of the coil core 14i. The pole shoe 21i can be a separate component or can be monolithically connected to the coil core 14i. In the embodiment shown in FIG. 1, two diametrically arranged coils 6a, 6b each have a coil core 14a, 14b and a pole shoe 21a, 21b. The two coil cores 14a, 14b are connected to one another via a field return 22. The field return 22 connects each of the sides of the coil cores 14a, 14b that face away from one another. However, magnetic-inductive flowmeters with exactly one coil 6 having exactly one coil core 14 and without a field return are also known. The coil 6 is connected to an operating circuit 7 which operates the coil 6 by means of an operating signal. The operating signal can be a voltage with a time-variable curve and is characterized by operating signal parameters, wherein at least one of the operating signal parameters is controllable. The magnetic field generated by the device 5 for producing the magnetic field is produced by means of a pulsed direct current of alternating polarity provided by an operating circuit 7. This ensures a stable zero point and makes the measurement insensitive to influences due to electrochemical disturbances. The two coils 6a, 6b can be separately connected to the operating circuit 7 or connected in series or in parallel with one another.

When the magnetic field is applied, a flow-rate-dependent potential distribution results in the measuring tube 2, which can be detected, for example, in the form of an induced measurement voltage. A device 8 for tapping off the induced measurement voltage is arranged on the measuring tube 2. In the embodiment shown, the device 8 for tapping off the induced measurement voltage is formed by two oppositely arranged measurement electrodes 17a, 17b in order to form a galvanic contact with the medium. However, it is known from magnetic-inductive flowmeters which comprise measurement electrodes arranged on the outer wall of the carrier tube 3 that are not in contact with the medium. The measurement electrodes 17a, 17b are generally arranged diametrically and form an electrode axis or are intersected by a transverse axis which runs perpendicular to the magnetic field lines and the longitudinal axis of the measuring tube 2. However, devices 8 intended for tapping off the induced measurement voltage and having more than two measurement electrodes are also known. The flow-rate-dependent measurement variable can be determined on the basis of the measured measurement voltage. The flow-rate-dependent measurement variable comprises the flow rate, the volumetric flow, and/or the mass flow of the medium. A measuring circuit 23 is designed to detect the induced measurement voltage applied to the measurement electrodes 17a, 17b, and an evaluation circuit 24 is designed to determine the flow-rate-dependent measured variable. The evaluation circuit 24 can be part of the transmitter.

The carrier tube 3 is often formed from an electrically conductive material such as steel. In order to prevent the measurement voltage applied to the first and second measurement electrodes 2, 3 from being conducted away via the carrier tube 3, the inner wall is lined with an insulating material, for example a liner 4 (made of plastic).

Commercially available magnetic-inductive flowmeters have two further electrodes 19, 20 in addition to the measurement electrodes 17a, 17b. In the first case, a fill level monitoring electrode 19 optimally attached at the highest point of the measuring tube 2 serves to detect partial filling of the measuring tube 1 and is configured to pass this information to the user and/or to take into account the fill level when determining the volumetric flow. In addition, a reference electrode 20, which is usually attached diametrically to the fill level monitoring electrode 19 or at the lowest point of the measuring tube cross section, serves to set a controlled electrical potential in the medium. As a rule, the reference electrode 20 is used to connect the flowing medium to a ground potential.

The operating circuit 7, controller circuit, measuring circuit and evaluation circuit can be part of a single electronic circuit or can form individual circuits. The measuring, operating and/or evaluation circuit 7, 23, 24 is designed to carry out the method according to the invention. For this purpose, the operating circuit is designed to generate the operating signal and provide it to the magnetic-field-generating device. Furthermore, the measuring circuit is designed to determine the measurement voltage values and forward them to the evaluation circuit. The evaluation circuit is designed to determine the current zero point and to take it into account for the determination of the flow-rate-dependent measurement variable.

The operating circuit 7 has the device 100 according to the invention for providing an excitation current for the magnetic-field-generating device.

### LIST OF REFERENCE SIGNS

Magnetic-inductive flowmeter 1
Measuring tube 2
Carrier tube 3
Liner 4
Magnetic-field-generating device 5
Operating circuit 7
Device for detecting an induced measurement voltage 8
Coil 13i
Coil core 14i
Measuring electrode 17i
Field return body 19
Pole shoe 21i
Fill-level monitoring electrode 22
Integrated circuit IC
First to eighth transistors T1-T8
H-bridge HB
Buck converter AbW
Boost converter AufW
Control logic AL
Microcontroller MCU
First electrical resistor R1
Second electrical resistor R2
First measuring unit M1
Second measuring unit M2
Storage unit C1
Digital-to-analog converter DAC
Analog-to-digital converter ADC

1-15. (canceled)

16. A device for providing an excitation current at a magnetic-inductive flowmeter for determining a flow-rate-dependent measured variable of a flowable medium, wherein the flowmeter includes a measuring tube, a magnetic-field-generating device, and a device for detecting an induced measuring voltage in the medium, the device for providing the excitation current comprising:
an integrated circuit, including:
an H-bridge including a first, a second, a third, and a fourth transistor, wherein the H-bridge is connected to an input of the magnetic-field-generating device via a first node and to an output of the magnetic-field-generating device via a second node;
a control logic which is designed to deliver control signals to respective inputs of the first, second, third, and fourth transistors of the H-bridge to control a provision of an operating signal to the magnetic-field-generating device by the H-bridge; and
a fifth transistor that is electrically connected to a buck converter that is part of the integrated circuit and is designed to convert an input voltage into a hold voltage wherein the control logic is designed to deliver control signals to an input of the fifth transistor to set a hold duration of the hold voltage and a frequency with which the hold voltage repeats; and
a microcontroller that is designed to deliver the operating signal to the integrated circuit and to receive measurement signals from the integrated circuit, wherein the microcontroller is arranged separately from the integrated circuit.

17. The device according to claim 16,
wherein the fifth transistor is an n-channel transistor.

18. The device according to claim 16,
wherein the integrated circuit further includes a sixth transistor that is electrically connected to a boost converter that is part of the integrated circuit and is designed to convert the input voltage into a shot voltage,
wherein the control logic is designed to deliver control signals to an input of the sixth transistor to set a shot duration of the shot voltage and a frequency with which the shot voltage repeats.

19. The device according to claim 18,
wherein the sixth transistor is a p-channel transistor.

20. The device according to claim 16, further comprising:
a first resistor that is arranged separately from the integrated circuit, wherein the H-bridge is connected to the first resistor via a third node and the first resistor is electrically connected to the fifth transistor,
wherein the integrated circuit further includes a first measuring unit that is connected in parallel to the first resistor and is designed to measure a voltage drop across the first resistor with respect to a provided reference potential and to provide the measured voltage drop as a measurement signal at an output IHigh for the microcontroller.

21. The device according to claim 20, further comprising:
a second resistor,
wherein the H-bridge is electrically connected via a fourth node to the second resistor that is arranged separately from the integrated circuit,
wherein the second resistor is electrically connected to the reference potential,
wherein the integrated circuit further includes a second measuring unit that is designed to measure a current through the second resistor and to provide the measured current as a measurement signal at an output ILow for the microcontroller.

22. The device according to claim 21,
wherein the second measuring unit is designed to amplify a voltage at an output SenseLow towards the second resistor.

23. The device according to claim 18,
wherein the integrated circuit further includes a seventh transistor that is connected in parallel to the H-bridge,
wherein the control logic is designed to deliver control signals to the input of the seventh transistor to bridge the H-bridge for diagnostics of the magnetic-field-generating device and/or of the H-bridge, including the first, second, third and/or fourth transistor.

24. The device according to claims 23,
wherein the integrated circuit further includes an eighth transistor that is electrically connected to an input for a reference potential,
wherein the control logic is designed to deliver control signals to the input of the eighth transistor to electrically set the magnetic-field-generating device to the reference potential.

25. The device according to claim 18, further comprising:
a storage unit;
wherein the fifth and sixth transistors are designed such that, in the event that a present voltage at a node connecting the fifth and sixth transistors is greater than a present voltage at the boost converter, excess energy of the magnetic-field-generating device is stored in the storage unit via the boost converter.

26. The device according to claim 16,
wherein the integrated circuit further includes a digital-to-analog converter that is designed to control the boost converter and/or the buck converter.

27. The device according to claim 16, further comprising:
a digital-to-analog converter that is designed to control the boost converter and/or the buck converter,
wherein the digital-to-analog converter is arranged separately from the integrated circuit.

28. The device according to claim 21,
wherein the integrated circuit further includes an analog-to-digital converter that is designed to convert the measured voltage drop and/or the measured current into a digital measurement signal.

29. The device according to 21, further comprising:
an analog-to-digital converter that is designed to convert the measured voltage drop and/or the measured current into a digital measurement signal,
wherein the analog-to-digital converter is arranged separately from the integrated circuit.

30. A magnetic-inductive flowmeter for determining a flow-rate-dependent measurement variable of a flowable medium, comprising:
a measuring tube for conducting the medium;
a magnetic-field-generating device for generating a magnetic field that penetrates the measuring tube;
an operating circuit for operating the magnetic-field-generating device;
wherein the operating circuit includes a device for providing an excitation current, including:
an integrated circuit, including:
an H-bridge including a first, a second, a third, and a fourth transistor, wherein the H-bridge is connected to an input of the magnetic-field-generating device via a first node and to an output of the magnetic-field-generating device via a second node;
a control logic which is designed to deliver control signals to respective inputs of the first, second, third, and fourth transistors of the H-bridge to control a provision of an operating signal to the magnetic-field-generating device by the H-bridge; and
a fifth transistor that is electrically connected to a buck converter that is part of the integrated circuit and is designed to convert an input voltage into a hold voltage wherein the control logic is designed to deliver control signals to an input of the fifth transistor to set a hold duration of the hold voltage and a frequency with which the hold voltage repeats; and
a microcontroller that is designed to deliver the operating signal to the integrated circuit and to receive measurement signals from the integrated circuit, wherein the microcontroller is arranged separately from the integrated circuit; and
a device for detecting an induced voltage in a medium.
